(19) United States
(12) Patent Application Publication
(10) Pub. No.: US 2013/0311234 A1
(43) Pub. Date: Nov. 21, 2013

(54) DEMAND-BASED OFFERINGS FOR SALE

(71) Applicant: Jeff Lloyd, Lindon, UT (US)

(72) Inventor: Jeff Lloyd, Lindon, UT (US)

(21) Appl. No.: 13/894,591

(22) Filed: May 15, 2013

Related U.S. Application Data
(60) Provisional application No. 61/649,139, filed on May 18, 2012.

(51) Int. Cl. G06Q 30/02

(52) U.S. Cl. CPC G06Q 30/0202
USPC 705/7.31

(57) ABSTRACT

An apparatus for a demand-based offering for sale is disclosed. A method and a computer program product also perform the functions of the apparatus. The apparatus includes a vote receiving module that receives a vote over a computer network from a user. The vote is related to an item in a potential sale list. The potential sale list includes items that may be sold. The apparatus includes a vote tabulating module that gives the items in the potential sale list a ranking according to the votes received by the vote receiving module, and a display module that displays the potential sale list online. The apparatus includes a sales module that offers the item with a highest ranking for sale for a period of time. The offer for sale includes an on-line offering.

### CROSS-REFERENCES TO RELATED APPLICATIONS

This application claims the benefit of U.S. Provisional Patent Application Number 61/649,139 entitled “DEMAND-BASED OFFERINGS FOR SALE” and filed on May 18, 2012 for Jeff Lloyd, which is incorporated herein by reference.

### FIELD

This invention relates to on-line purchase and more particularly relates to online demand-based offerings for sale of items.

### BACKGROUND

An increasing number of products are sold online. Online sales are convenient for shoppers because the shoppers can visit numerous websites of stores in a matter of minutes. Online sales of products, however, suffer from unique problems. Millions of products are offered online and are only distinguished by a website address. Marketing campaigns help to elevate one website over another, but online advertising suffers because so many products are advertised online that consumers are bombarded by emails and website advertising all vying for the attention of the consumer. Consumers often tune out emails and other online advertising. Consumers are often drawn to websites offering a good deal on a product, but often products offered at a discount are products that the consumers don't want.

### SUMMARY

An apparatus for a demand-based offering for sale is disclosed. A method and a computer program product also perform the functions of the apparatus. The apparatus includes a vote receiving module that receives a vote over a computer network from a user. The vote is related to an item in a potential sale list. The potential sale list includes items that may be sold. The apparatus includes a vote tabulating module that gives the items in the potential sale list a ranking according to the votes received by the vote receiving module, and a display module that displays the potential sale list online. The apparatus includes a sales module that offers the item with a highest ranking for sale for a period of time. The offer for sale includes an on-line offering.

In one embodiment, the vote receiving module further receives a suggestion over the computer network from a user. The suggestion is related to an item to be added to the potential sale list. In another embodiment, the vote includes a positive vote where the positive vote promotes increasing the ranking of an item on the potential sale list. In another embodiment, the vote includes a negative vote where the negative vote promotes decreasing the ranking of an item on the potential sale list. In another embodiment, the vote includes a contract vote or a non-contract vote. The contract vote includes a contractual obligation to purchase the item if the item is offered for sale. In a further embodiment, the contract vote promotes increasing the ranking of an item more than a non-contract vote.

In one embodiment, the vote includes an extension-type vote where the extension-type vote includes a request that an offering for sale remains an offering for sale for a duration longer than a pre-determined duration. In another embodiment, the apparatus includes an item description module that describes the items in the potential sale list. In a further embodiment, the item description module includes a side-by-side comparison of similar items, comments and reviews from users and other purchasers, and/or an expected purchase price. In another embodiment, the display module displays a specific quantity of items where the items displayed include items with a higher ranking than other items. In another embodiment, the vote receiving module receives a certain number of votes per user per day.

In another embodiment, the apparatus includes an analytics module that monitors vote information and sales information. The vote information includes information associated with votes from users related to items in the potential sale list and the sales information includes information associated with items purchased by users. In a further embodiment, the analytics module also includes user-vote statistics, vote-purchase statistics, similar item vote statistics, similar item purchase statistics, and/or user demographic information. In another embodiment, the apparatus includes a supplier access module that allows suppliers to view the potential sale list and the rankings associated with each item. In a further embodiment, the supplier access module further allows suppliers to input an expected price, an expected price range, an expected price per volume sold, and/or an item description.

A method for demand-based offerings for sale includes receiving a vote over a computer network from a user. The vote is related to an item in a potential sale list and the potential sale list includes items that may be sold. The method includes giving the items in the potential sale list a ranking according to the received votes, displaying the potential sale list online, and offering the item with a highest ranking for sale for a period of time where the offer for sale includes an on-line offering.

In one embodiment, the method includes receiving a suggestion over the computer network from a user. The suggestion is related to an item to be added to the potential sale list. In another embodiment, the vote includes a positive vote or a negative vote. The positive vote promotes increasing the ranking of an item on the potential sale list and the negative vote promotes decreasing the ranking of an item on the potential sale list. In another embodiment, the vote includes a contract vote or a non-contract vote. The contract vote includes a contractual obligation to purchase the item if the item is offered for sale and the contract vote promotes increasing the ranking of an item more than a non-contract vote.

The method may be embodied by a computer program product that includes a computer readable storage medium having program code embodied therein. The program code is readable and/or executable by a processor.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for selling items according to users' demand in accordance with an embodiment of the present invention;

FIG. 2 is a schematic block diagram illustrating one embodiment of a apparatus for selling items according to users' demand in accordance with an embodiment of the present invention;

FIG. 3 is a schematic block diagram illustrating another embodiment of an apparatus for selling items according to users' demand in accordance with an embodiment of the present invention;

FIG. 4 is a schematic block diagram illustrating one embodiment of a display generated by the display module in accordance with an embodiment of the present invention;

FIG. 5 is a schematic flow chart diagram illustrating one embodiment of a method for selling items according to users' demand in accordance with an embodiment of the present invention; and

FIG. 6 is a schematic flow chart diagram illustrating another embodiment of a method for selling items according to users' demand in accordance with an embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored on and/or propagated in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

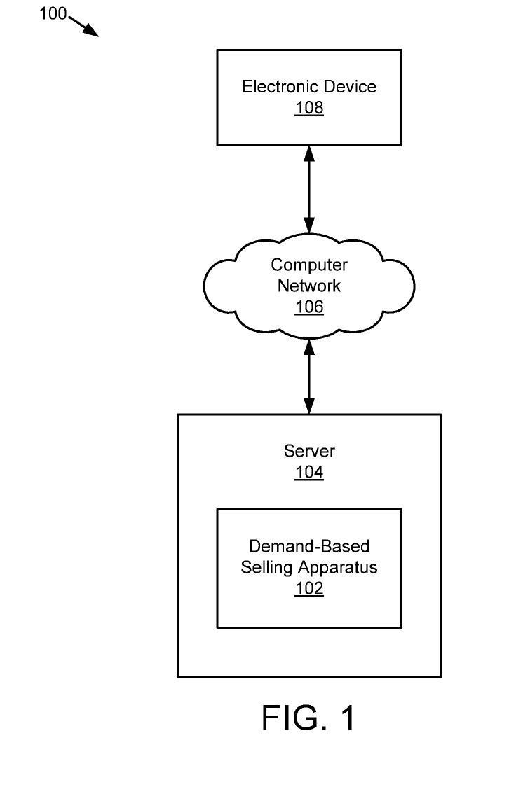

FIG. 1 is a schematic block diagram illustrating one embodiment of a system 100 for selling items according to users' demand in accordance with the present invention. The system 100, in one embodiment, includes a demand-based sales apparatus 102, a server 104, a computer network 106, and an electronic device 108 accessed by a user, which are described below.

The demand-based sales apparatus 102, in one embodiment, receives votes, from users, related to items on a potential sale list and ranks the items according to the votes received and periodically the item with the highest ranking will be offered for sale. The demand-based sales apparatus 102 may be part of a server 104 as shown accessible by an electronic device 108 through a computer network 106 or may be installed on or accessible by a computing device, such as a desktop computer, workstation, laptop computer, tablet computer, a mobile computing device such as a cellular phone or smartphone, or any other computing device with access to a computer network 106. The computing device may be a user accessing the demand-based sales apparatus 102 by way of the server 104. In one embodiment, the computing device includes the demand-based sales apparatus 102 and accesses information located on the server 104. The server 104 may be part of a cloud computing environment accessible by the computing device. One of skill in the art will recognize other ways of implementing the demand-based sales apparatus for user access using a computing device.

The computer network 106 may be a single network or may include several computer networks 106 linked together. The computer network 106 may include a local area network (“LAN”), wide area network (“WAN”), wireless network, etc. and may include a combination of networks. The computer network 106 may include hardware such as the server 104, routers, switches, cabling, and other communication hardware. The computer network 106 may include the internet and access remote web servers with web pages that satisfy search criteria for a web search. Web pages available to the demand-based sales apparatus may be located within a proprietary computer network 106, such as within one or more servers 104, one or more web servers, etc. of a company or may be located external to a proprietary computer network 106 and may be available for public access. In various embodiments, web pages may include information about the items being sold, such as item data, diagrams of the items, photographs of the items, consumer reviews on the items, detailed descriptions of the items, or any other item related content. One of skill in the art will recognize other content and web pages available for access by a demand-based sales apparatus 102 over one or more computer networks 106.

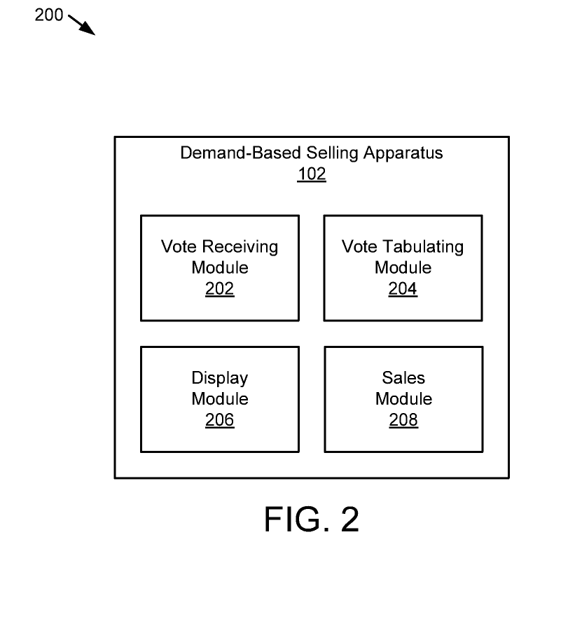

FIG. 2 is a schematic block diagram illustrating one embodiment 200 of a demand-based sales apparatus 102 for selling items according to users' demand in accordance with the present invention. The demand-based sales apparatus 102, in one embodiment, includes a vote receiving module 202, a vote tabulating module 204, a display module 206, and a sales module 208, which are described below.

The vote receiving module 202, in one embodiment, receives votes from users over a computer network 106 and the votes are related to items on a potential sale list. As discussed briefly above, a user may cast a vote using various electronic devices 108 which have access to a computer network 106. For example, a user may download an application (“App”) onto a phone which functions as the vote receiving module 202 or a user may visit a website to cast votes. The website may be an independent website for receiving votes or the website may be a third-party social media website such as Facebook®, Twitter®, MySpace®, and the like. In another embodiment, the vote receiving module 202 receives votes via Short Message Service (“SMS”) text messaging, email, or phone calls. A user may be any person with access to a computer network 106 and, in one embodiment, a user may register and set up an account on the server 104 and create a user profile.

The votes are generally related to items on a potential sale list that may be offered for sale. An item may be any good for sale, such as a television, a phone, a computer, a gift certificate, a piece of furniture, etc. In one embodiment, an item may include a service such as a professional service, a cleaning service, a yard service, a car service, a healthcare service, a media service, and the like. An item may be a similar good from a competing manufacturer of another good. An item may also include groups of items, such as bundled packages, bundled good and services, etc. The potential sales list may include a finite number of items, e.g. 50 items, or the potential sales list may include any item that may be sold. The potential sale list may also allow items to be on the list for a specific period of time before the item expires. For example, if an item has been on the potential sale list for several weeks, that item may be subsequently removed from the list because the item's time on the potential sale list had expired.

In one embodiment, a user may have a certain number of votes to cast over a certain period of time. In other words, a vote may have a generation rate and a duration period. The generation rate, in one example, represents the number of votes that become available, over time, for a user to cast and the duration period, in another example, represents the useable lifetime of each vote, i.e. the length of time that a user has to cast a vote before the vote expires. For example, each user may only be given 3 votes to cast per 24 hour period; if a user does not cast all of the votes during the 24 hour period, the user forfeits the ability to cast the un-used/expired votes. In another example, each user may be given 3 votes per day but the votes may rollover to future days so that a user can save votes over a few days time and then cast multiple votes at once. In one embodiment, a user may cast multiple votes on a single item. In another embodiment, a user may cast multiple votes on several different items.

Different types of votes may also be available to a user. For example, both positive votes and negative votes may be available to a user. A positive vote is cast in favor of an item being offered for sale may increase the likelihood that the voted-for item will become available for purchase. A negative vote is cast in favor of an item not being offered for sale and may decrease the likelihood that the voted-for item will become available for purchase. A user may, in some embodiments, be given a certain number of votes that can be used as either positive or negative votes, or a user may be given a certain number of positive votes and a certain number of negative votes.

Other types of votes may be received by the vote receiving module 202, such as public/private votes and group voting. Users, in one embodiment, may cast votes privately so that other users do not see which items were voted for, or users may cast their votes publicly so that users can see each other's votes. In one embodiment, a group-type vote may also be received by the vote receiving module 202, which includes a group of users combining their votes into one large group vote. The joint group vote may, in one example, have more influence in ranking a product than if the individual votes that comprise the group vote were cast separately and independently.

In another embodiment, a user has an option to cast a contract vote. A contract vote represents a contractual obligation for the user to purchase the voted-for item if the item becomes available for purchase. The contract vote may have more influence in ranking a product than a non-contract vote. The contract vote, in some embodiments, may also be conditioned upon other terms, such as purchase price (discussed below with reference to the sales module 208 as depicted in FIG. 2), number of positive votes cast for the item, number of negative votes cast for the item, number of unique users voting for an item, etc. The contract vote may also involve a credit card authorization so that a seller has verification of a user's intent to purchase a voted-for item at an expected price (sellers and purchase price will be discussed below with reference to the sales module 208 as depicted in FIG. 2).

The vote tabulating module 204, in one embodiment, ranks the items in the potential sales list according to votes received by the vote receiving module 202. As discussed above, since a vote may be either positive or negative or may be one of several different types, the ranking of items may include several different implementations. In one implementation the vote tabulating module 204 arranges the items on the potential sale list according to the number of positive votes received for each item. In another implementation, the vote tabulating module 204 includes both positive and negative votes in the ranking and the items in the potential sales list are arranged accordingly. In yet another implementation, the vote tabulating module 204 only considers the number of unique users that voted for each item and arranges the list based on how many individual users voted for each item and does not consider how many individual votes were cast for each item.

In one embodiment, the potential sale list includes multiple lists or multiple subdivisions/sections. For example, the vote tabulating module 204 may arrange items into various lists according to the type of vote and other descriptive information. For example, the vote tabulating module 204 may arrange items on a first list according to a ranking based upon contract votes, a second list according to a ranking based upon positive votes, a third list according to a ranking based upon votes received for items in a certain price range, and so on and so forth. In other words, the vote tabulating module 204 may arrange items in multiple potential sale lists in order to compare and contrast the rankings according to different aspects of the items and votes, such as price, voting rate, item description, item category, type of vote, etc.

The vote tabulating module 204 may also negate votes for various reasons, such as if an item is out of stock, is limited in number, is not yet available, or if the expected purchase price of an item is inaccurate. Negated votes may, in one embodiment, be forfeited or the negated votes may be reimbursed or given back to a user so that the user may re-cast the votes on a different item.

In one embodiment, the vote tabulating module 204 continuously ranks the items as the vote receiving module 202 receives the votes. In another embodiment, the vote tabulating module 204 periodically ranks the items in the potential sale list, for example, the vote tabulating module 204 may rank the items once per hour or once per day, etc. In another embodiment, the vote tabulating module 204 includes multiple ranking lists, such as a list arranged to identify the rankings that were received by items during a certain period of time, i.e. a “hot list” identifying which items were voted for the most during a specific time period. The vote tabulating module 204 may also arrange and rank similar items (i.e. items from the same category, e.g. televisions) to identify which items in a specific category are ranked the highest or which items in a specific category are receiving votes at a higher rate.

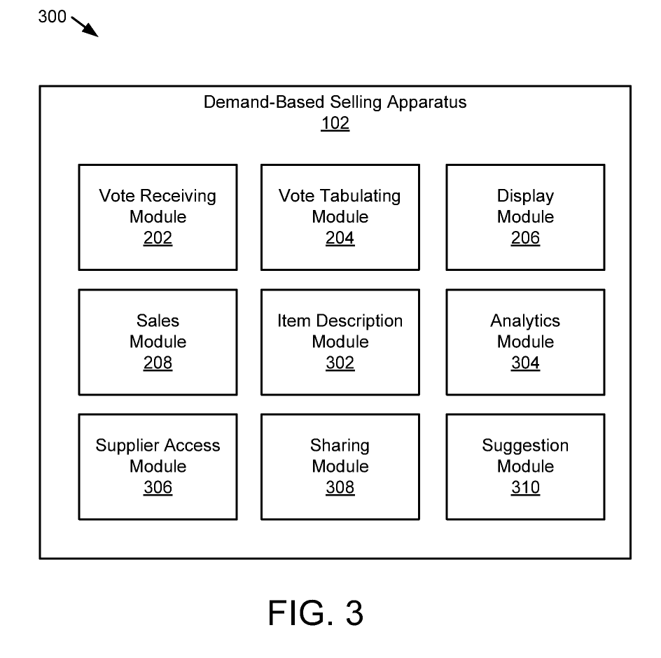

The display module 206, in one embodiment, displays online the ranked items in the potential sale list. In one embodiment, the display module 206 displays only a portion of the potential sale list, such as the portion of the list with comparatively higher ranked items. In another embodiment, the display module 206 displays all of the items in the potential sale list. The display module 206 may display the items alone or the display module 206 may display each item with the item's corresponding ranking. Further, the display module 206 may display a description of each item, which will be discussed below in greater detail with reference to the description module 302 as depicted in FIG. 3. The items in the potential sale list may be displayed in several different manners, including alphabetically, by ranking, by type of product, by manufacturer, by expected price, or by other means. The ranked items in the potential sale list may be displayed on a website, as part of an application (“App”), in an email, etc.

The display module 206, in one embodiment, may display the potential sale list on a computer screen, a smartphone, a tablet or other electronic device. In one embodiment, the display module 206 includes a computer screen, a smartphone screen, etc. Updates or changes to the rankings, in various embodiments, may be communicated via Twitter ®, SMS text message, email, website application or other notification system. The display module 206 may display the items in a typical list format or the display module 206 may display the items in other formats, such as using tables, graphs, images, charts, etc. In one embodiment, the item(s) with the highest ranking(s) may especially manifest, such as at the top of a list, through the use of color, bold font, larger-sized font, images, more detailed description, etc. The display module 206 may also display the items that are for sale, as will be discussed in greater detail below. In one embodiment, the display module 206, displays the potential sale list as part of an application that is in use, opened, or may take a large portion of a display screen. In another embodiment, the display module 206, displays the potential sale list off to a side of a main display, in a background, as part of another application, etc. One of skill in the art will recognize other ways for the display module 206 to display the potential sale list.

The sales module 208, in one embodiment, offers the item with the highest ranking for sale for a period of time. The sales module 208 may periodically offer one or more items for sale, for example, once per day. The sales module 208, in another embodiment, may offer a single item for sale or the sales module 208 may offer multiple items for sale at the same time. The periodic offerings may be substantially constant, i.e. daily, weekly, bi-weekly, monthly, annually, etc. In another embodiment, the offerings are not constant and at various times there will be multiple offers for items for sale and at others there will be no offers for items for sale.

The sales module 208, in various embodiments, may offer items for sale for only a certain period of time, for example, one hour, one day, one week, one month, one year, etc. Once an item has been offered for sale, in one embodiment the item is no longer on the potential sale list and the item moves to an offering for sale list. In another embodiment, an item for sale remains on the potential sale list but may be highlighted or distinguished in some way as being for sale. In another embodiment, an item in the offering for sale list can be put back on the potential sale list, but the ranking will be reset to zero. In another embodiment, an item offered for sale retains some or all of its previous ranking.

In one example, the sales module 208 offers the item with the highest ranking for sale daily, and the offer for sale lasts for one week. If on Monday morning at 8:00 AM (the predetermined time to offer an item for sale) the item with the highest ranking is a laptop computer, the laptop computer will be moved from the potential sale list to an offering for sale list, where users and others can purchase the laptop for a period of 7 days. Since this process occurs daily (in this example), there will generally be 7 items on the offering for sale list at one time. Once an item has spent 7 days on the offering for sale list, the offering expires and a new one replaces it. One of skill in the art will recognize other ways to offer an item for sale. The sales module 208 may also include payment processing support which allows users and others to purchase the items.

It is also contemplated that extension-type votes, in various embodiments, may be received by the vote receiving module 202 or by the sales module 208. For example, if users wish for an item to remain on the offering for sale list for a period longer than the predetermined duration, users may, in one embodiment, cast extension-type votes to increase the duration of items on the offering for sale list. For example, extension-type votes cast by users may reach an extension threshold and the duration of a sale period for an item may be extended in response to extension-type votes exceeding the extension threshold. In one embodiment, only users who have cast a certain type of vote (e.g. a contract type vote) may cast extension-type votes. As discussed above, there also may be times when more items are offered for sale, during which times the offering for sale list may be larger or items may expire more rapidly.

FIG. 3 is a schematic block diagram illustrating another embodiment 300 of a demand-based sales apparatus 102 for selling items according to users' demand in accordance with the present invention. The demand-based sales apparatus 102, in one embodiment, includes a vote receiving module 202, a vote tabulating module 204, a display module 206, and a sales module 208, which are substantially similar to the modules described above with reference to FIG. 2. The demand-based sales apparatus 102 may also include an item description module 302, an analytics module 304, a supplier access module 306, a sharing module 308, and a suggestion module 310, which are described below.

In one embodiment, the demand-based sales apparatus 102 includes an item description module 302 that reports and/or receives descriptive information about each product in the potential sale list or in the offering for sale list. The descriptive information may include, among others, a general description of an item, a side-by-side comparison of similar items, comments from users, consumer reviews on an item, an expected purchase price, and an expected purchase price range. The description module 302 may be configured with the display module 206 to display descriptive information next to each item on the potential sale list or on the offering for sale list.

In one embodiment, the potential sale list and the offering for sale list include a brief description or a summary of the descriptive information and a user can click on or otherwise access a full-description of the item by navigating to a different area of a website or by linking to other websites with descriptive information, such as manufacture websites, consumer review websites, etc. In another embodiment, users and others may contribute to the descriptive information by submitting comments, reviews, or otherwise sharing opinions about an item. The item description module 302 may receive description updates and revisions from a supplier access module 306, which will be discussed in greater detail below with reference to the supplier access module 306.

In one embodiment, the demand-based sales apparatus 102 includes an analytics module 304 that monitors and records vote information and sales information. Vote information is defined herein as information, data, statistics, or trends related to users' casting votes and sales information is defined herein as any information, data, statistics, or trends related to users purchasing items. For example, the analytics module 304 may record the number of negative votes that an item received and analyze statistics and trends relating to the users and their votes. Other examples of vote information and sale information include, but are not limited to, user-vote statistics, vote-purchase statistics, similar item-vote statistics, similar item-purchase statistics, voting trends, and user demographic information. In other words, the analytics module monitors and records any type of analytical data that is received by the vote receiving module 202 and the sales module 208 and from user registration.

In one embodiment, the demand-based sales apparatus 102 includes a supplier access module 306 that allows suppliers to view and contribute information relating to items on the potential sale list or the offering for sale list. A supplier may be any manufacturer, producer, or distributor that wishes to include an item to be potentially sold in the demand-based sales apparatus 102. In some embodiments, the suppliers are registered sellers that have received access to portions of the item description module 302 and/or portions of the demand-based selling apparatus 102 in general. For example, if a supplier wishes to sell an item with the demand-based selling apparatus 102, the supplier may, in one embodiment, be required to register as a verified seller and may need to pay a fee for access to the demand-based selling apparatus 102.

A supplier may view the items and rankings on the potential sale list and may input information, in conjunction with the item description module 302, such as expected price of an item, expected price range of an item, expected price of an item per volume sold, item descriptions, external links to item descriptions, etc. The supplier access module 306 generally allows the supplier to see the status of the voting and ranking process and the supplier access module 306 may allow suppliers to influence the voting and ranking process by changing the purchase price or by adding more detailed description to the an item's descriptive information. For example, a supplier may see that an item is substantially high in the rankings and the supplier may lower the price to encourage more votes so that the item will be ranked the highest and will be moved to the offering for sale list.

A supplier may also use the supplier access module 306 to set up a vote-volume based pricing scheme or a purchase-volume based pricing scheme, among others. For example, a supplier may enter a vote-volume based pricing scheme into the supplier access module 306 so that the price of a particular item changes according to the votes received by the vote receiving module 202 for that particular item. In one example, a supplier may initially set the price for a television at $700 and that price may change (automatically through a pricing scheme or manually by the supplier) to $650 when, for example, 1,000 votes are received in favor of the television or when the television reaches a certain ranking as assigned by the vote tabulating module 204.

In another example, the supplier access module 306 may allow a supplier to view other information related to the items, such as user reviews and user comments, which would be of value to suppliers as a form of product feedback. It is contemplated that the supplier access module 306 may give various levels of access to the demand-based sales apparatus 102 to suppliers according to various factors, such as the number of items that a particular supplier previously sold using the demand-based sales apparatus 102, contractual agreements, the pricing of the supplier's items, supplier registration fees, etc.

In one embodiment, the demand-based sales apparatus 102 includes a sharing module 308 that allows users to publish, share, communicate or otherwise divulge information relating to the items on the potential sale list and items on the offering for sale list. For example, a user may utilize the sharing module 308 to invite others to vote for an item on the potential sale list. In another example, a user may invite others to purchase an item on the offering for sale list. The user may send invitations or otherwise share information using the sharing module 308 through various forms of communication, including Facebook®, Twitter®, MySpace®, SMS text messaging, email, etc.

In one embodiment, the demand-based sales apparatus 102 includes a suggestion module 310 that receives suggestions, from users, related to items. A suggestion represents a user's request that the user would like to see a certain item on the potential sale list, i.e. items that the user would like to be able to vote on. A suggestion may be substantially similar to votes in terms of generation rate, duration period, type, etc. The suggestion module 310 may, in one embodiment, allow users to pick from a list of items which items they would like to see on the potential sale list. In other words, the suggestion module 310 may include a finite list of suggestible items.

In another embodiment, the suggestion module 310 may allow users to suggest any item to be added to the potential sale list by submitting a description of an item and other identifying information. For example, a user may fill out a suggestion form which may include, among others, the name of the suggested item, the manufacturer of the suggested item, the type or category of the suggested item, the price range of the suggested item, items similar to the suggested item, etc. The suggestion module 310 may recommend to the suggesting user similar items that are currently on the potential sale list or the suggestion module 310 may propose certain items that substantially meet the description submitted by the user in the user's suggestion request.

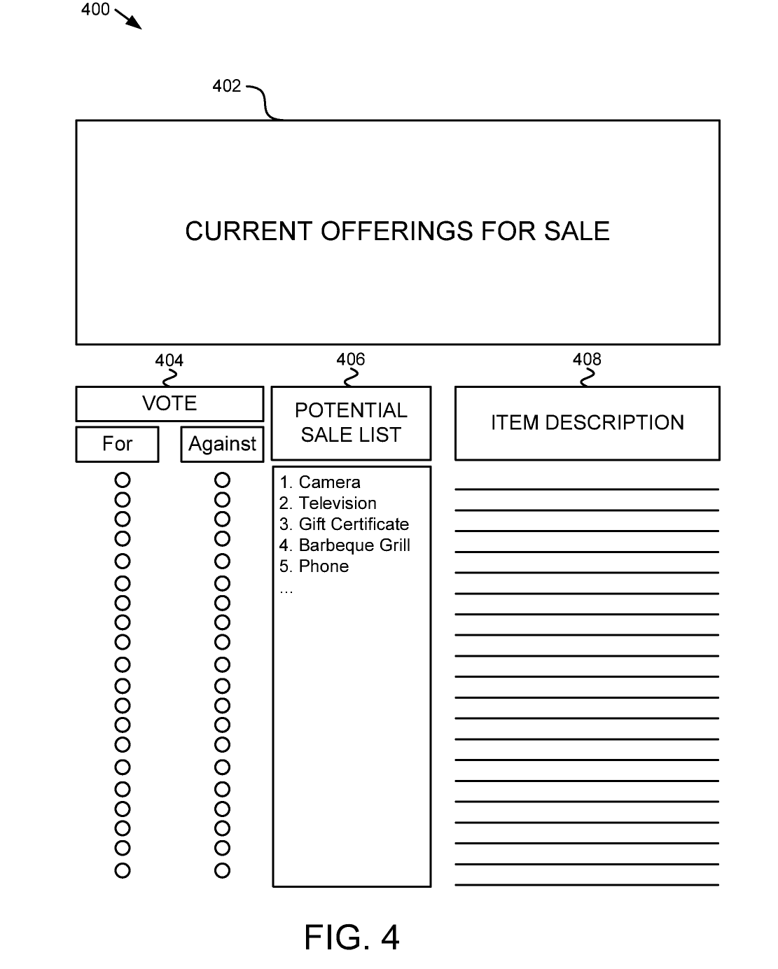

FIG. 4 is a schematic block diagram illustrating one embodiment of a display generated by the display module 206 in accordance with the present invention. The embodiment depicts a computer screenshot 400 of a display generated by the display module 206. The screenshot 400 includes displaying along the top of the screen 402 the items on the offering for sale list. This offering for sale list, in various embodiments, may include purchase price, descriptions, number of votes, number of purchases, etc. In one embodiment, a user can purchase the items on the offering for sale list by clicking or otherwise selecting or accessing the item. The screenshot 400 also includes a voting section 404 where users may enter either a positive or a negative vote by voting for or against an item on the potential sale list 406, respectfully. In one embodiment, a user may also access a summary description section 408 of the items and may be able to access more detailed descriptions of each item by clicking on individual summary descriptions 408.

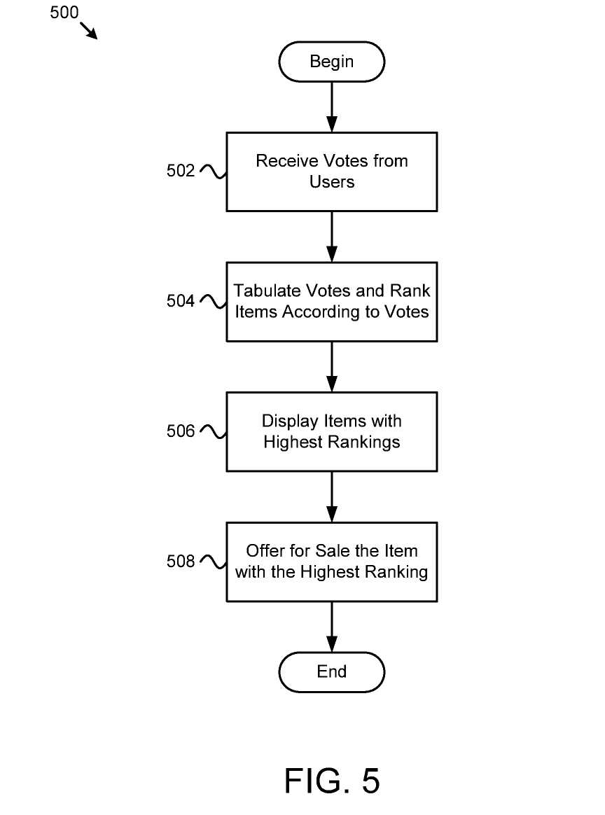

FIG. 5 is a schematic flow chart diagram illustrating one embodiment of a method 500 for selling items according to users' demand in accordance with the present invention. The method begins and receives 502 votes over a computer network from a user. The vote is related to an item in a potential sale list and the potential sale list includes items that may be sold. The vote may be one of various types, including a positive vote, a negative vote, a contract vote, a group vote, a private vote, a public vote, a suggestion, etc. The user may use an electronic device 108 to cast the vote over a computer network 106. In one example, a user accesses an electronic device and visits a website where the user may cast votes. The user, in one embodiment, may choose to cast a contract vote, which means that the user is contractually obligated to purchase the item if the item were to ever be offered for sale.

The method 500 gives 504 the items in the potential sale list a ranking according to the received votes. In one embodiment, the vote tabulating module 204 gives 504 the items in the potential sales list a ranking. In one example, the vote tabulating module 204 would give an item that received 10 positive votes and 5 negative votes a comparatively higher ranking than an item that received 10 positive votes and 10 negative votes. If a user casts a contract vote, the contract vote would, in one embodiment, promote the increase of the ranking of the item comparatively more than a non-contract positive vote.

The method 500 displays 506 the potential sale list online, according to the rankings assigned by the vote tabulating module. The display may include items with comparatively higher rankings or it may include the entirety of the potential sale list. The display may also include an offering for sale list. For example, a user may view the displayed potential sale list and/or the offering for sale list online and may choose to cast a vote, share displayed item and vote information with others, purchase an item, etc.

The method 500 offers 508 offers the item with the highest ranking for sale for a period of time, and the method 500 ends. The offer for sale includes an on-line offering. In one embodiment, the item with the highest ranking is offered for sale. In another embodiment, the sales module 208 offers the item for sale. In one example, the sales module 208 daily offers the item with the highest ranking for sale. The offering for sale may have a duration of, in one embodiment, one week.

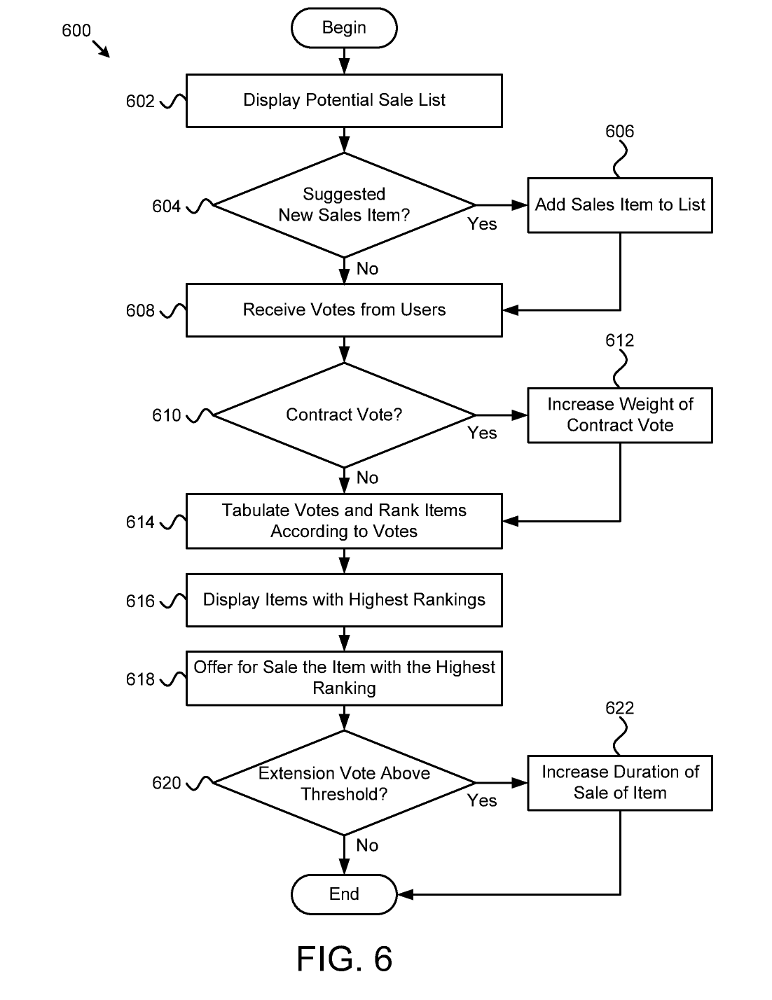

FIG. 6 is a schematic flow chart diagram illustrating another embodiment of a method 600 for selling items according to users' demand in accordance with an embodiment of the present invention. The method 600 begins and displays 602 a list of potential sale items. The potential sale items may include items submitted by a vendor, items suggested by a user, items in stock, or other items that may be potentially sold. In one embodiment, the potential sale items are displayed electronically, for example on a website. The method 600 determines 604 if there is a suggestion for an additional item to be added to the potential sale item list. For example, a user may suggest an item for sale, for example using the suggestion module 310.

If the method 600 determines 604 that there is a suggestion for an additional item to be added to the potential sale item list, the method 600 adds 606 the additional item to the potential sale item list. If the method 600 determines 604 that there is not a suggestion for an additional item to be added to the potential sale item list, the method receives 608 votes from users. For example, users may submit votes through the vote receiving module 202. The method 600 determines 610 if any of the received votes are contract votes. If the method 600 determines 610 that there are contract votes, the method 600 increases 612 weight of the contract votes. The method 600 tabulates 614 votes and ranks the potential sale items based on the tabulated votes. In one embodiment, the vote tabulating module 204 tabulates and ranks the votes.

The method 600 displays 616 the items with the highest rankings and offers 618 for sale the items with the highest rankings. For example, the display module 206 displays the items for sale and the sale module 208 offers the items for sale. In one embodiment, the method 600 determines 620 if a number of extension votes are above an extension vote threshold. If the method 600 determines 620 that the number of extension votes exceeds the extension vote threshold, the method 600 increases 622 duration of the sales item with the extension votes, and the method 600 ends. If the method 600 determines 620 that the number of extension votes does not exceed the extension vote threshold, the method 600 ends. The method 600 is one possible embodiment of an invention for demand-based offerings for sale. One of skill in the art will recognize that other methods may be implemented using the various modules and descriptions included herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a vote receiving module that receives a vote over a computer network from a user, the vote related to an item in a potential sale list, the potential sale list comprising items that may be sold;
a vote tabulating module that gives the items in the potential sale list a ranking according to votes received by the vote receiving module;
a display module that displays the potential sale list online; and
a sales module that offers the item with a highest ranking for sale for a period of time, the offer for sale comprising an on-line offering.

2. The apparatus of claim 1, wherein the vote receiving module further receives a suggestion over the computer network from a user, the suggestion related to an item to be added to the potential sale list.

3. The apparatus of claim 1, wherein the vote comprises a positive vote, the positive vote promoting increasing the ranking of an item on the potential sale list.

4. The apparatus of claim 1, wherein the vote comprises a negative vote, the negative vote promoting decreasing the ranking of an item on the potential sale list.

5. The apparatus of claim 1, wherein the vote comprises one of a contract vote and a non-contract vote, the contract vote comprising a contractual obligation to purchase the item if the item is offered for sale.

6. The apparatus of claim 5, wherein the contract vote promotes increasing the ranking of an item more than a non-contract vote.

7. The apparatus of claim 1, wherein the vote comprises an extension-type vote, the extension-type vote comprising a request that an offering for sale remains an offering for sale for a duration longer than a pre-determined duration.

8. The apparatus of claim 1, further comprising an item description module that describes the items in the potential sale list.

9. The apparatus of claim 8, wherein the item description module comprises one or more of a side-by-side comparison of similar items, comments and reviews from users and other purchasers, and an expected purchase price.

10. The apparatus of claim 1, wherein the display module displays a specific quantity of items, wherein the items displayed comprise items with a higher ranking than other items.

11. The apparatus of claim 1, wherein the vote receiving module receives a certain number of votes per user per day.

12. The apparatus of claim 1, further comprising an analytics module that monitors vote information and sales information, the vote information comprising information associated with votes from users related to items in the potential sale list and the sales information comprising information associated with items purchased by users.

13. The apparatus of claim 12, wherein the analytics module further comprises one or more of user-vote statistics, vote-purchase statistics, similar item vote statistics, similar item purchase statistics, and user demographic information.

14. The apparatus of claim 1, further comprising a supplier access module that allows suppliers to view the potential sale list and the rankings associated with each item.

15. The apparatus of claim 14, wherein the supplier access module further allows suppliers to input one or more of an expected price, an expected price range, an expected price per volume sold, and an item description.

16. A method comprising:
receiving a vote over a computer network from a user, the vote related to an item in a potential sale list, the potential sale list comprising items that may be sold;
giving the items in the potential sale list a ranking according to received votes;
displaying the potential sale list online; and
offering the item with a highest ranking for sale for a period of time, the offer for sale comprising an on-line offering.

17. The method of claim 16, further comprising receiving a suggestion over the computer network from a user, the suggestion related to an item to be added to the potential sale list.

18. The method of claim 16, wherein the vote comprises one of a positive vote and a negative vote, the positive vote promoting increasing the ranking of an item on the potential sale list, the negative vote promoting decreasing the ranking of an item on the potential sale list.

19. The method of claim 16, wherein the vote comprises one of a contract vote and a non-contract vote, the contract vote comprising a contractual obligation to purchase the item if the item is offered for sale, the contract vote promoting increasing the ranking of an item more than a non-contract vote.

20. A computer program product comprising a computer readable storage medium having program code embodied therein, the program code readable/executable by a processor to:
receiving a vote over a computer network from a user, the vote related to an item in a potential sale list, the potential sale list comprising items that may be sold;
giving the items in the potential sale list a ranking according to received votes;
displaying the potential sale list online; and
offering the item with a highest ranking for sale for a period of time, the offer for sale comprising an on-line offering.
